(19) United States
(12) Patent Application Publication
(10) Pub. No.: US 2026/0004565 A1
(43) Pub. Date: Jan. 1, 2026

(54) RE-LEARNING SUPPORT SYSTEM, RE-LEARNING SUPPORT METHOD, AND STORAGE MEDIUM

(71) Applicant: Evident Corporation, Kamiina-gun (JP)

(72) Inventors: Yuki ARAI, Kamiina-gun (JP); Sho MAKITA, Kamiina-gun (JP); Yosuke TANI, Kamiina-gun (JP); Hiroshi TAKISAWA, Kamiina-gun (JP); Takuma DEZAWA, Kamiina-gun (JP)

(73) Assignee: Evident Corporation, Kamiina-gun (JP)

(21) Appl. No.: 19/071,770

(22) Filed: Mar. 6, 2025

(30) Foreign Application Priority Data
Jun. 26, 2024 (JP) 2024-102453

(51) Int. Cl. G06V 10/774; G06V 10/70; G06V 10/776; G06V 10/94; G06V 20/69

(52) U.S. Cl. CPC G06V 10/774; G06V 10/776; G06V 10/87; G06V 10/945; G06V 20/69

(57) ABSTRACT

A storage stores one or more trained models trained using at least one microscopic image, one or more revisions associated with each of the trained models and indicating versions of the trained model, and one or more pieces of design information for the trained model associated with the one or more revisions. The processor receives a selection of at least one of the trained models, acquires one or more revisions and one or more pieces of design information for the selected trained model from a storage, displays a name of the selected trained model in a first display area of a model design information screen, and displays the acquired revisions and the acquired design information in association with each other in a second display area of the model design information screen.

### CROSS REFERENCE TO RELATED APPLICATIONS

This application is based upon and claims the benefit of priority of the prior Japanese Patent Application No. 2024-102453, filed Jun. 26, 2024, the entire contents of which are incorporated herein by reference.

### BACKGROUND OF THE INVENTION

### Field of the Invention

The disclosure in the present specification relates to a re-learning support system, a re-learning support method, and a storage medium.

### Description of the Related Art

A technology has been known in which re-learning is performed using a non-defective product image or a defective product image and an image recognized by a user as an additional image for an image inspection device that determines a quality of an object from a captured image of the object using a discriminator obtained by machine learning (for example, see JP 7287791 B2).

In addition, the technology called TMRNet has been known as a technology for recognizing an action for a task from a video of the task (for example, see Yueming Jin, et al., “Temporal Memory Relation Network for Workflow Recognition from Surgical Video”, IEEE Transactions on Medical Imaging, Volume 40, Issue 7, July 2021). TMRNet is an abbreviation for temporal memory relation network, and is a technology for specifying what task an action shown in a current frame is on the basis of a relationship between a plurality of frames.

### SUMMARY OF THE INVENTION

A re-learning support system according to an aspect of the present invention includes a storage and a processor. The storage stores one or more trained models, one or more pieces of version information associated with each of the trained models, and one or more pieces of design information for the trained model associated with the one or more pieces of version information. The one or more trained models are models trained using at least one microscopic image. The processor receives a selection of at least one of the trained models, and acquires one or more pieces of version information and one or more pieces of design information for the selected trained model from the storage. Then, the processor displays information about the selected trained model in a first display area of a display, and displays the acquired version information and the acquired design information in a second display area of the display in association with each other.

### BRIEF DESCRIPTION OF THE DRAWINGS

FIG. 1 is a flowchart illustrating an example of a procedure of AI model creation work;

FIG. 2 is a flowchart illustrating an example of a procedure of AI model update work;

FIG. 3 is a diagram illustrating an example of a re-learning support system;

FIG. 4 is a diagram illustrating an example of a hardware configuration of a computer;

FIG. 5 is a diagram illustrating an example of a data structure of a model design information DB;

FIG. 6 is a diagram illustrating the number of the number of class classifications of a video;

FIG. 7 is a diagram illustrating an example of a data structure of a model-related file information DB;

FIG. 8 is a flowchart illustrating processing details in an example of re-learning support processing;

FIG. 9 is a diagram illustrating an example of a model selection screen;

FIG. 10 is a flowchart illustrating processing details in an example of model design information screen processing;

FIG. 11 is a diagram illustrating a first example of a model design information screen;

FIG. 12 is a flowchart illustrating processing details in an example of sorting processing;

FIG. 13 is a diagram illustrating a second example of a model design information screen;

FIG. 14 is a flowchart illustrating processing details in an example of video tag information screen processing;

FIG. 15 is a diagram illustrating an example of a video tag information screen;

FIG. 16 is a flowchart illustrating processing details in an example of model performance comparison screen processing;

FIG. 17 is a diagram illustrating an example of a model performance comparison screen;

FIG. 18 is a flowchart illustrating processing details in an example of score transition display screen processing;

FIG. 19 is a diagram illustrating an example of a score transition display screen; and

FIG. 20 is a flowchart illustrating processing details in an example of re-learning processing.

### DESCRIPTION OF THE EMBODIMENTS

An inference model (trained model) generated by machine learning can be used to classify what task a video of a work process captured using a microscope with respect to an object is for. When this trained model is actually used, re-learning may be repeatedly performed to obtain an updated version of the trained model, for example, whenever there is a change in the work process or in order to meet a demand for improvement in classification accuracy.

When re-learning is performed, design information for each trained model of old version (such as the time at which the model was created, information about videos as teacher data, conditions under which the videos were captured, the performance of the model at the time of creation, information about the worker that is a subject, and the like) is important in tracing the intention and background of the design of each model of the old version.

Hereinafter, embodiments will be described in detail with reference to the drawings.

Even today, when automation of work is progressing using robots or the like, there are still many products that require manual assembly, and a medical device is one example thereof. Precision devices such as medical devices are often assembled under a microscope because many minute tasks are required. For such work, a stereo microscope that allows an object to be viewed in stereoscopic view with both eyes is often used. Such work under the microscope is highly difficult, and prone to variation in work.

In order to suppress variation in work, the responsible of the work may be limited to a trained worker. On the other hand, since the variation in the work depending on the skill level of the person is inevitable, the work under the microscope may be recorded in order to check the state of the work and the appropriateness of the result of the work. As a method of recording the work, a video capturing the state or the result of the work may be acquired by a microscope camera.

The amount of the video obtained in this manner is huge in daily product production. For this reason, it is not realistic for a reviewer to check what task each video segment, which is a part of the video, corresponds to among a series of assembly processes one by one. Therefore, recently, a method has been proposed in which an AI model divides a video that records a series of assembly processes and classifies them for different tasks. Note that “AI” is an abbreviation for artificial intelligence. For example, the above-described TMRNet can be used as an AI model for this purpose.

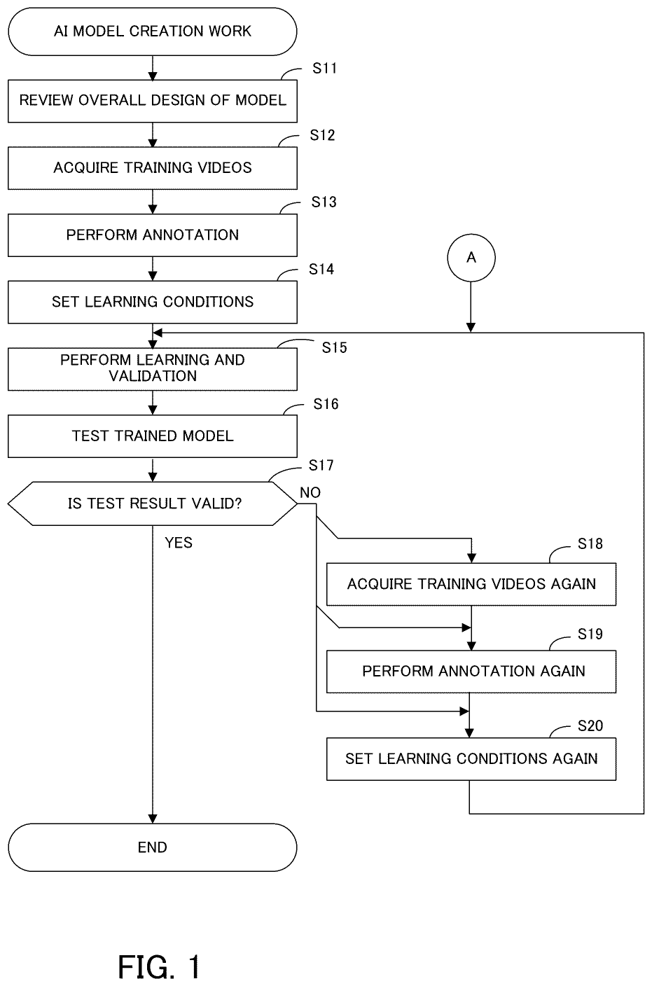

Here, work for creating an AI model that classifies each task in a product assembly process will be described. FIG. 1 is a flowchart illustrating an example of a procedure of AI model creation processing.

In the AI model creation work, first, work of reviewing an overall design (e.g., how many video segments a video is to be divided into and what tasks the video segments are to be classified into) of the AI model to be created is performed (S11). Next, work of acquiring training videos showing tasks in the assembly process is performed (S12).

Next, work of annotating each of the videos acquired by the work in S12 according to the result of the review work in S11 is performed (S13). The annotation work is work of adding a mark as an annotation to an image frame at a boundary between two consecutive video segments as an annotation when the target video is divided into a plurality of video segments.

Next, work of setting various conditions (learning conditions) in machine learning for creating the AI model is performed (S14). By this setting work, for example, the number of iterations of learning and a threshold for determining convergence of learning are set.

Next, under the learning conditions set by the work in S14, work of performing machine learning and validating a learning result is performed using the training videos including annotations obtained by the work up to S13 as teacher data (S15).

Next, as a test of the AI model obtained as a result of the learning work in S15, work of classifying tasks shown in a video different from the teacher data by the AI model is performed (S16). Then, work of determining whether a result of this test is valid is performed (S17).

Here, when it is determined that the result of the test is valid, the AI model creation processing ends. On the other hand, here, when it is determined that the test result is not valid, work for re-creating an AI model are performed. Specifically, work of acquiring training videos again (S18), work of annotating the videos again (S19), and work of setting learning conditions again (S20) are repeated for trials and errors until it is determined that the result of the test in S16 is valid.

The AI model is completed by, for example, such creation processing.

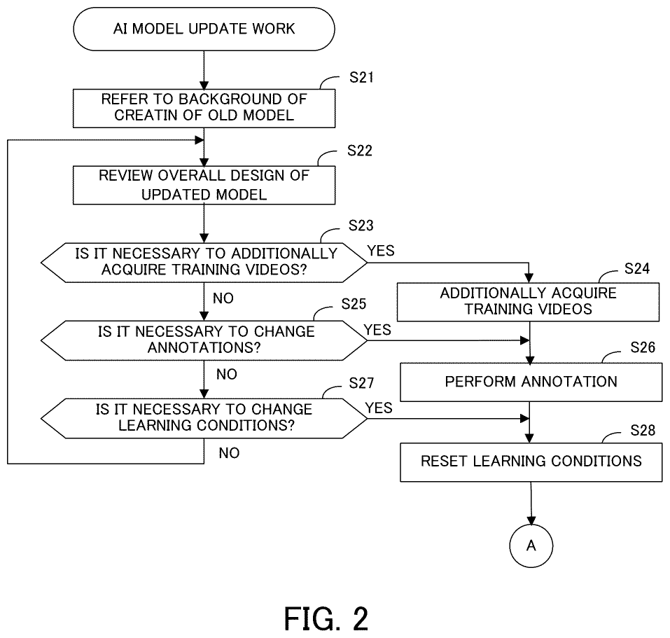

By the way, after the AI model is created, it may be necessary to update the AI model under a certain circumstance such as a change to the assembly process or a demand for improvement in task classification accuracy. Next, AI model update processing will be described. FIG. 2 is a flowchart illustrating an example of a procedure of AI model update processing.

When it is necessary to update the AI model, first, design information at the time of creating the current version of the AI model to be updated and each version before the current version of the AI model to be updated are referred to (S21). Next, work of reviewing an overall design of the updated version of the AI model is performed on the basis of the design information referred to in S21 (S22). Note that the design information includes, for example, the time at which the model was created, information about videos as teacher data, conditions under which the videos were captured, the performance of the model at the time of creation, and information about the worker that is a subject.

By referring to the design information through the work in S21, a model developer who performs the AI model update processing can grasp the intention and the background of the design at the time of creating the old version of the AI model, and obtain an updated version of the AI model that solves a problem in the old version of the AI model derived from the intention and the background of the design.

Next, work of determining whether it is necessary to additionally acquire new training videos different from those used in machine learning for creating the old version of the AI model is performed on the basis of the result of the review work in S22 (S23).

Here, when it is determined that the additional acquisition is necessary, work of additionally acquiring training videos (S24), work of annotating the additionally acquired videos (S26), and work of resetting learning conditions according to the additional acquisition of the videos (S28) are sequentially performed. Then, thereafter, as re-learning work, the work of performing machine learning and validation in S15, the work in S16, and the subsequent work in the AI model creation work illustrated in FIG. 1 are sequentially performed.

On the other hand, when it is determined that it is not necessary to additionally acquire training videos, next, work of determining whether it is necessary to change the annotations added to the already acquired training videos used for creating the old version of the AI model is performed on the basis of the result of the review work in S22 (S25).

Here, when it is determined that it is necessary to change the annotations, work of annotating the acquired training videos to change the annotations (S26) and work of resetting learning conditions accompanying the change of the annotations (S28) are sequentially performed. Then, thereafter, as re-learning work, the work of performing machine learning and validation in S15, the work in S16, and the subsequent work in the AI model creation work illustrated in FIG. 1 are sequentially performed.

On the other hand, when it is determined that both the additional acquisition of training videos and the change of the annotations are unnecessary, next, work of determining whether it is necessary to reset learning conditions is performed on the basis of the result of the review work in S22 (S27).

Here, when it is determined that it is necessary to reset learning conditions, work of resetting learning conditions (S28) is performed. Then, thereafter, as re-learning work, the work of performing machine learning and validation in S15, the work in S16, and the subsequent work in the AI model creation work illustrated in FIG. 1 are sequentially performed.

On the other hand, when it is determined that all of the additional acquisition of training videos, the change of the annotations, and the resetting of learning conditions are unnecessary, the review work in S22 is performed again, and then the work in S23 and the subsequent work are performed again.

When the update work of the AI model is completed as described above, the data of the AI model after the update is overwritten on the data of the AI model before the update and saved. Note that, instead of saving the data in the overwritten manner, the data of the AI model after the update may be newly saved as data of a model different from the data of the AI model before the update.

For example, it is assumed that work of updating an AI model to which “trained model 1” is assigned as a model name is performed. In this case, when data is saved in the overwritten manner, setting information and the like associated with the model name “trained model 1” are taken over as they are while the data of the model is updated. Furthermore, at this time, the revision associated with the AI model is updated.

On the other hand, in the above-described case, when the data of the AI model after the update is newly saved as data of another model, the data of the model reflecting the update work performed on the model named “trained model 1” is saved in a different name, for example, as “trained model 1′”. At this time, the AI model named “trained model 1′” takes over the setting information and the version information associated with the AI model named “trained model 1”, but the version information is updated from the “trained model 1”. This is useful, for example, in a case where it is desired to prepare AI models for different work environments or for different system operation environments, or in a case where it is desired to save an old model as a backup in a separate file.

In the AI model update work, for example, the above-described work is performed. In this work procedure, the review work in S22 serves as the basis for carrying out the subsequent work, and the design information for each AI model of the old version referred to in the work in S21 is used for this review work. Therefore, if this design information can be easily obtained, the burden of the AI model update work, that is, the work for re-training the trained AI model is reduced.

Therefore, in the following description, as an embodiment of the present invention, a system will be described, the system supporting AI model update work performed by a model developer by displaying design information for each trained AI model created in the past in association with information indicating each version of the AI model.

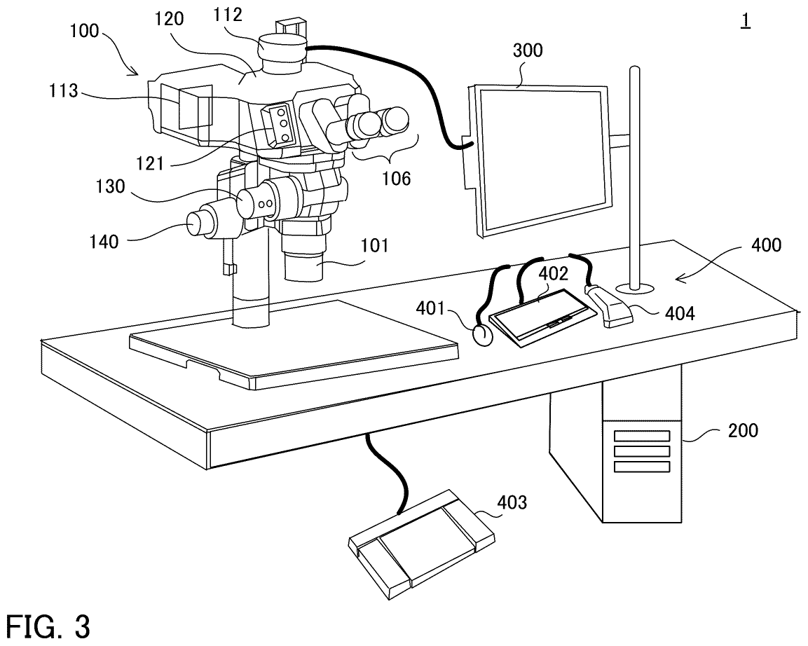

First, FIG. 3 will be described. FIG. 3 illustrates an overall configuration of an example of a re-learning support system 1.

The re-learning support system 1 includes a microscope 100, a control device 200, a monitor 300, and a plurality of input devices 400 (a mouse 401, a keyboard 402, a foot switch 403, a barcode reader 404).

The microscope 100 is a stereoscopic microscope capable of stereoscopically viewing a sample. A user can observe an optical image formed on an object side of an eyepiece 106 by a microscope optical system with the left and right eyes via the eyepiece 106, and can stereoscopically observe the object. The microscope 100 is suitable for use, for example, in work of assembling a precision device.

The microscope 100 includes a zoom lens operable using a zoom handle 130. By operating the zoom handle 130, the user can change the observation magnification while continuing to look into the eyepiece 106 and observe the object.

The microscope 100 includes a focusing handle 140. By operating the focusing handle 140, the user can change the distance between the object and an objective lens 101 to focus on the object.

The microscope 100 includes an imaging device 112 that images the object and acquires a moving image of the object. An eyepiece barrel 120 to which the eyepiece 106 is attached is a trinocular lens barrel, and the imaging device 112 is attached to the eyepiece barrel 120. The imaging device 112 includes a two-dimensional image sensor. The image sensor is not particularly limited, and is, for example, a CCD image sensor, a CMOS image sensor, or the like. The moving image acquired by the imaging device 112 is output to the control device 200. Furthermore, the moving image may be directly output to the monitor 300.

Light branched by, for example, a beam splitter such as a half mirror from an optical path of an optical system (not illustrated) included in the microscope 100 is incident on the imaging device 112 via an image forming lens (not illustrated).

The microscope 100 includes a projector 113 that projects an auxiliary image on an image plane where the image forming lens forms an optical image. The projector 113 is a device that projects and superimposes an auxiliary image on an image plane in accordance with a command from the control device 200. More specifically, the projector 113 superimposes the auxiliary image on the image plane on the basis of auxiliary image data to be described later. Note that the type of the projector 113 is not particularly limited. The projector 113 may be configured, for example, using a liquid crystal device or a digital mirror device.

The projector 113 is provided in the eyepiece barrel 120. Light from the projector 113 is guided to the optical path of the optical system of the microscope 100.

The eyepiece barrel 120 includes an operation unit 121. By operating the operation unit 121, the user can switch on and off the projector 113 to give an instruction for starting or stopping superimposing an auxiliary image on the image plane.

The control device 200 controls the microscope 100. The control device 200 generates the auxiliary image data described above and outputs the auxiliary image data to the microscope 100 (the projector 113).

The monitor 300 and the input devices 400 are connected to the control device 200. The monitor 300 is, for example, a liquid crystal display, an organic EL display, or the like, and functions as a display in the re-learning support system 1. The “EL” is an abbreviation for electro-luminescence.

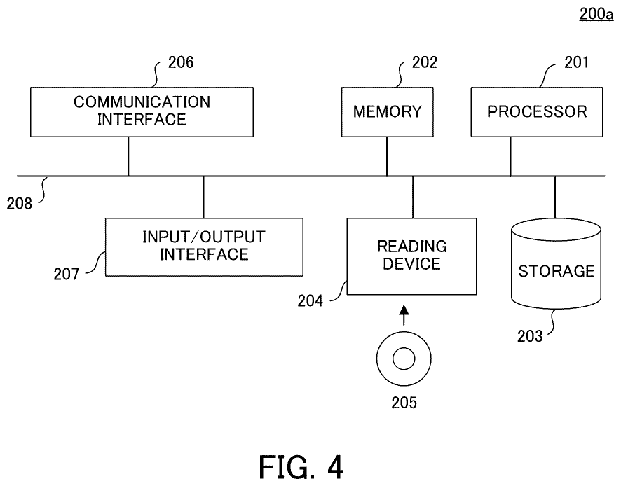

FIG. 4 illustrates an example of a hardware configuration of a computer 200a for realizing the control device 200 in the re-learning support system 1 described above. The computer 200a includes, for example, a processor 201, a memory 202, a storage 203, a reading device 204, a communication interface 206, and an input/output interface 207 as hardware. Note that the processor 201, the memory 202, the storage 203, the reading device 204, the communication interface 206, and the input/output interface 207 are connected to each other, for example, via a bus 208.

The processor 201 may be, for example, a single processor, a multiprocessor, or a multi-core processor. The processor 201 reads and executes programs stored in the storage 203 to perform various types of control processing including re-learning support processing to be described later, and provides a function as a control unit in the re-learning support system 1.

The memory 202 is, for example, a semiconductor memory, and may include a RAM area and a ROM area. Note that the “RAM” is an abbreviation for random access memory, and the “ROM” is an abbreviation for read only memory.

The storage 203 is, for example, a semiconductor memory such as a hard disk or a flash memory, or an external storage, and provides a function as a storage unit in the re-learning support system 1. More specifically, the storage 203 stores, for example, configuration data for one or a plurality of trained models trained using moving images (at least one microscopic image) captured by the imaging device 112 of the microscope 100. The storage 203 also stores a model design information DB 500, a model-related file information DB 600, and the like, which will be described later. The “DB” is an abbreviation for database.

The reading device 204 accesses a removable recording medium 205, for example, according to an instruction of the processor 201. The removable recording medium 205 is realized, for example, by a semiconductor device, a medium to and from which information is input and output by a magnetic action, a medium to and from which information is input and output by an optical action, or the like. Note that the semiconductor device is, for example, a universal serial bus (USB) memory. Furthermore, the medium to which information is input and output by a magnetic action is, for example, a magnetic disk. The medium to and from which information is input and output by an optical action is, for example, a compact disc (CD)-ROM, a digital versatile disk (DVD), or a Blu-ray (registered trademark) disc, or the like.

The communication interface 206 communicates with other devices (for example, the microscope 100 and the like), for example, according to an instruction of the processor 201. The input/output interface 207 is, for example, an interface between the input device 400 and an output device. The input device 400 is, for example, a device such as the mouse 401, the keyboard 402, the foot switch 403, or the like that receive an instruction from the user. The output device is, for example, the monitor 300 or an audio device such as a speaker. Note that various operations such as a “click operation” to be described below are described as operations performed by the mouse 401 as an example, but are not limited to operations performed by the mouse 401 as long as the operations are designation operations using the input device 400.

For example, the programs that the processor 201 executes are provided to the computer in the following forms:
(1) installed in the storage 203 in advance;
(2) provided by the removable recording medium 205; and
(3) provided from a server such as a program server.

Note that the hardware configuration of the computer 200a for realizing the control device 200 described with reference to FIG. 4 is exemplary, and the embodiment is not limited thereto. For example, a part of the configuration described above may be omitted, or a new configuration may be added to the configuration described above. In another embodiment, for example, some or all functions of the control device 200 may be implemented as hardware. A field programmable gate array (FPGA), a system-on-a-chip (SoC), an application specific integrated circuit (ASIC), and a programmable logic device (PLD) are examples of hardware by which the control device 200 can be implemented.

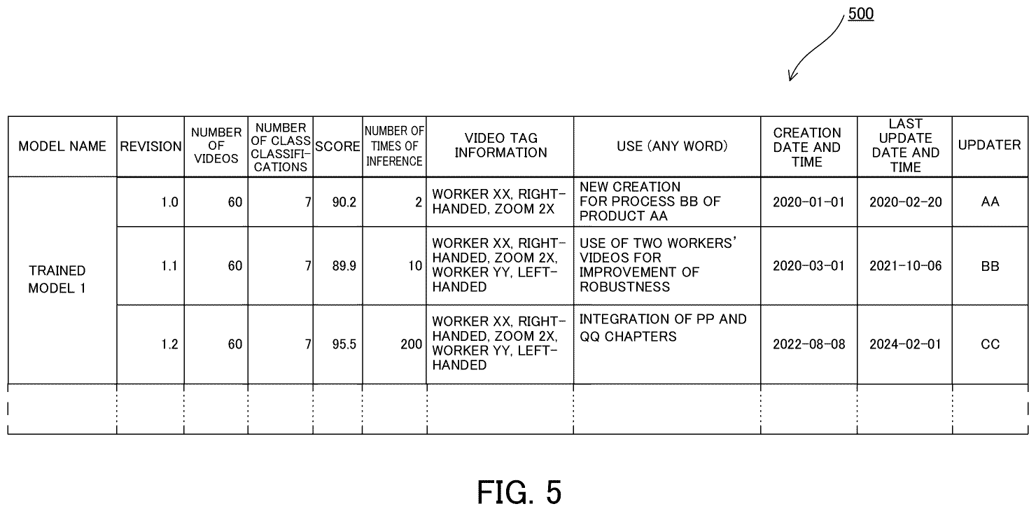

Next, the model design information DB 500 stored in the storage 203 will be described. FIG. 5 illustrates an example of a data structure of the model design information DB 500.

Each of the trained models stored in the storage 203 is associated with version information indicating a version of the trained model. In the model design information DB 500 of FIG. 5, for each trained model, one or a plurality of pieces of version information indicating the version of the trained model and one or a plurality of pieces of design information for the trained model are associated with each other. Note that, in FIG. 5, “model name” is a name given to the AI model (trained model), and “revision” is an example of version information. The design information is information including at least one of time information, person information, training information, and textual information. In FIG. 5, “the number of videos”, “the number of class classifications”, “score”, and “number of times of inference” are examples of training information, and “video tag information” and “updater” are examples including person information. In addition, “use (any word)” is an example of textual information, and “creation date and time” and “last update date and time” are examples of time information. That is, in the model design information DB 500 of FIG. 5, the design information for the trained model is associated with the “revision” that specifies the version of the trained model.

The design information of FIG. 5 will be further described.

The “number of videos” is information about the number of training videos used for machine learning performed at the time of creating the trained model.

The “number of class classifications is information about the number of classes when the trained model classifies one video obtained by capturing an assembly process with the microscope 100 into video segments for several tasks constituting the assembly process.

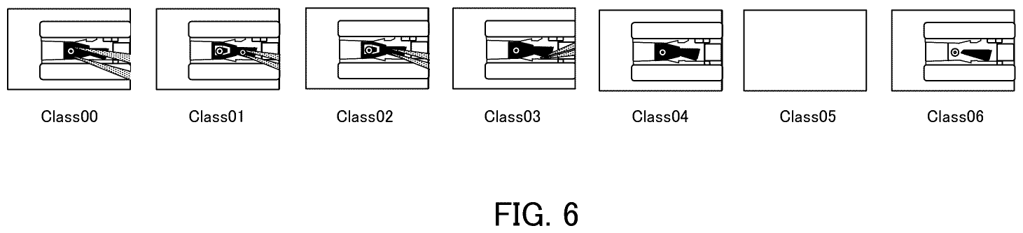

For example, it is indicated in a video of a process of assembling a certain part exemplified in FIG. 6 that one video is classified into video segments from “Class 00” to “Class 06” for tasks constituting the assembly process. Therefore, in this example, the “number of class classifications” is “7”.

Returning to the description with reference to FIG. 5, the “score” is information about a value obtained by quantitatively evaluating the trained model, and is information about a value indicating a level of reliability in the classification from the video of the assembly process into the video segments for the respective tasks performed by the trained model. In the present embodiment, the score is calculated on the basis a convergence value of a loss function calculated during machine learning at the time of creating the trained model. Note that a value calculated by another method may be used as the “score”.

The “number of times of inference” is the number of times of inference performed using the trained model, that is, information about the number of times of classification from the video of the assembly process to video segments for the respective tasks actually using the trained model.

The “video tag information” is tag information added to data of the training videos used for machine learning at the time of creating the trained model. For example, the name of the worker who has performed the task in the assembly process, information about the dominant hand of the worker, and observation information such as the configuration and the observation magnification of the microscope 100 used for capturing the video are attached to the training video for the assembly process stored in the storage 203. The “video tag information” indicates all the tag information attached to each of the training videos used for machine learning.

The “use ((any word))” is textual information expressing information regarding the creation of the trained model, such as an intention and a background of designing the trained model, and is information input by a model developer who created or updated the trained model.

The “creation date and time” is information about the date and time when the trained model was created or updated.

The “last update date and time” is information about the date and time when the design information for the trained model was updated.

The “updater” is information about the name of the model developer who created or updated the trained model.

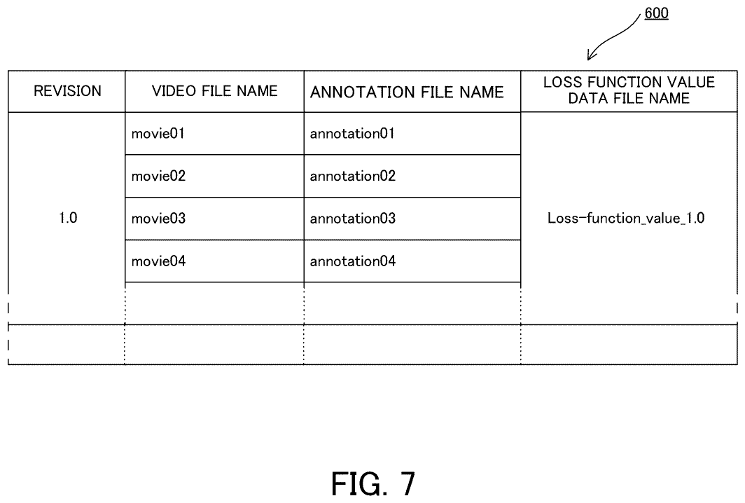

Next, the model-related file information DB stored in the storage 203 will be described. FIG. 7 illustrates an example of a data structure of the model-related file information DB 600.

As described above, the configuration data for the trained model is stored in the storage 203. The storage 203 also stores various data files related to the trained model. The model-related file information DB 600 is used to manage the association between these data files and the trained model.

In the model-related file information DB 600 exemplified in FIG. 7, the “revision” as version information indicating the version of the trained model is associated with a name of a data file stored in the storage 203 for each trained model.

The “video file name” is information about a file name of a video data file of a training video used for machine learning performed at the time of creating the trained model.

The “annotation file name” is information about a file name of an annotation file for the training video indicated by the “video file name” and used for machine learning performed at the time of creating the trained model. Note that the annotation file is a data file that stores information regarding annotations, such as information indicating positions in the training video at which annotations are added to the training video at the time of the machine learning.

The “loss function value data file name” is information about a file name of a loss function value data file for machine learning performed at the time of creating the trained model. Note that the loss function value data file is a file that stores data in which the number of iterations of learning in the machine learning performed at the time of creating the trained model is associated with a loss function value at each iteration of learning. The loss function value data file is used to display a model performance comparison screen to be described later.

In the model-related file information DB 600 exemplified in FIG. 7, annotation files are managed for each revision of the trained model. Alternatively, an annotation file may be managed for each video file. That is, one video file may be associated with one annotation file, and annotation information for the video file may be managed for each revision of the trained model in the corresponding annotation file. Furthermore, annotation information for each revision of the trained model with respect to the video file may be embedded in the video file, and annotations for each revision of the trained model may be managed in the video file.

Next, various kinds of processing performed by the processor 201 will be described.

### [1: Re-Learning Support Processing]

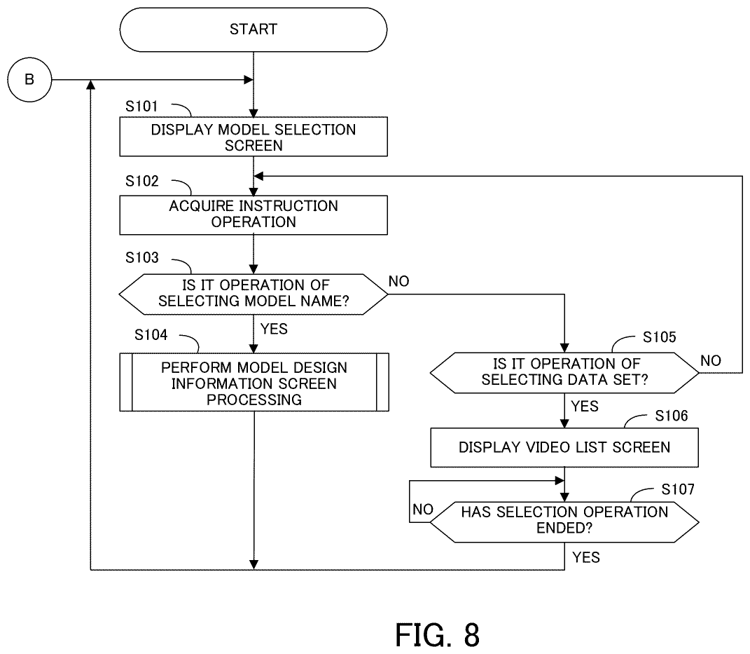

First, re-learning support processing will be described. FIG. 8 is a flowchart illustrating processing details in an example of re-learning support processing;

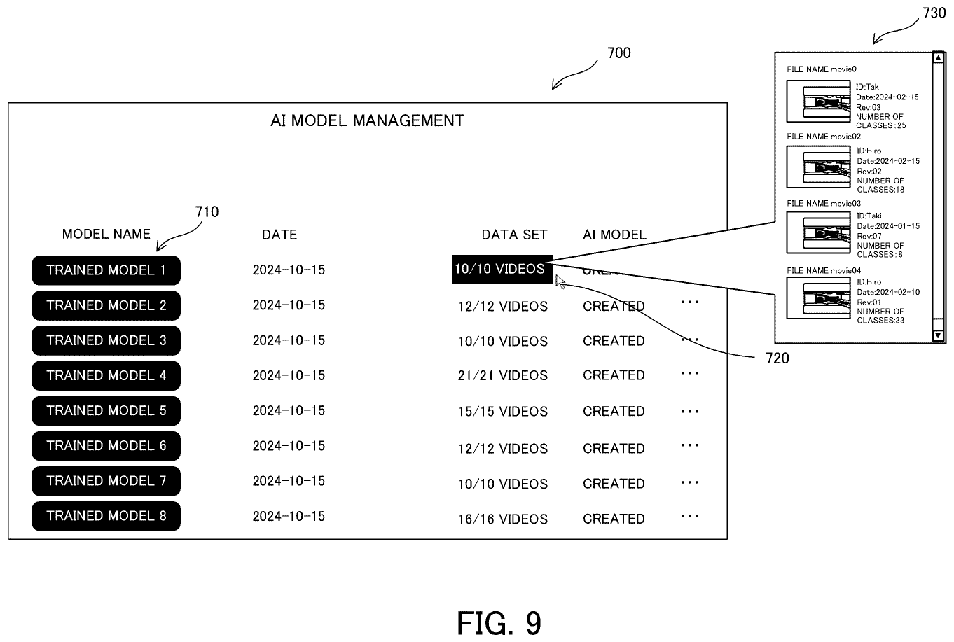

The execution of the re-learning support processing is started when the processor 201 acquires an instruction to start the processing from a model developer who performs trained model update work by operating the input device 400. When the execution of the processing is started, first, in S101, a model selection screen 700 illustrated in FIG. 9 is displayed on the monitor 300 connected to the input/output interface 207.

Here, the model selection screen 700 of FIG. 9 will be described. On the model selection screen 700, the following types of information are associated with each other: “model name”, “date”, “data set”, and “AI model”.

The “model name” is a name of an AI model in which configuration data is stored in the storage 203, and the “date” is a date when the AI model is created. These types of information are acquired from the model design information DB 500 described above and displayed on the model selection screen 700.

The “data set” indicates the number of training videos planned to be used for machine learning at the time of creating the AI model and the number of training videos actually used for machine learning. When the numerical values on both sides of the diagonal line in the “data set” are the same, it indicates that all the planned training videos have been used for machine learning.

Furthermore, the “AI model” indicates the status of the creation of the trained model, and the “created” indicates that the creation of the AI model has already been completed. In the example of FIG. 9, all the “AI models” are marked “created”, which indicates that work of creating all the AI models whose model names are displayed on the model selection screen 700 of FIG. 9 has been completed.

Note that the processor 201 generates these kinds of information displayed on the model selection screen 700 by using the information shown in the model design information DB 500 and the model-related file information DB 600.

Referring back to FIG. 8, the description will be made. When the model selection screen 700 is displayed on the monitor 300, next, in S102, an instruction operation on the input device 400 is acquired. Then, in S103, it is determined whether the acquired instruction operation is an operation of selecting a model name of an AI model.

On the model selection screen 700 illustrated in FIG. 9, model selection buttons 710 indicating model names of AI models are arranged as the “model name”. The model selection button 710 is an icon button, and an operation of clicking the model selection button 710 is detected as an operation of selecting the model name of the AI model.

When it is determined in the determination processing of S103 that the acquired operation is for selecting a model name, model design information screen processing is performed in S104. The model design information screen processing is processing for switching the screen displayed on the monitor 300 from the model selection screen 700 to a model design information screen 800 to be described later. This processing will be described in detail later.

Thereafter, when the model design information screen processing ends, the processing returns to S101, and a model selection screen 700 is displayed again.

On the other hand, when it is determined in the determination processing of S103 that the acquired instruction operation is not an operation of selecting a model name, it is determined whether the instruction operation acquired in S102 is an operation of selecting a data set in S105.

On the model selection screen 700 exemplified in FIG. 9, a mouse pointer 720 points to a position at which the data set for the “trained model 1” is displayed, and an operation of moving the mouse pointer 720 to this position is detected as an operation of selecting a data set.

When it is determined in the determination processing of S105 that the acquired instruction operation is an operation of selecting a data set, a video list screen 730 is displayed in a popped-up manner on the monitor 300 displaying the model selection screen 700 in S106. On the other hand, when it is determined in the determination processing of S105 that the acquired instruction operation is not an operation of selecting a data set, the processing returns to S102, and an instruction operation is acquired again.

Note that the video list screen 730 is a screen displaying a list of information regarding the training videos used for machine learning at the time of generating the AI model specified by the model name corresponding to the data set on which the selection operation has been performed. In the example of FIG. 9, as this information, the creator name (“ID”), the creation date (“Date”), the revision (“Rev”) of the annotation work, and the number of class classifications (“the number of classes”) are shown for the training video. This information is included in the tag information attached to the training video or the annotation file for the training video.

Following the processing of S106, it is determined in S107 whether the operation of selecting the data set acquired by the processing of S102 has ended. This determination processing is repeated until it is determined that the selection operation has ended. When it is determined that the selection operation has ended, the processing returns to S101, and the popped-up display of the video list screen 730 ends and a model selection screen 700 is displayed again.

### [2: Model Design Information Screen Processing]

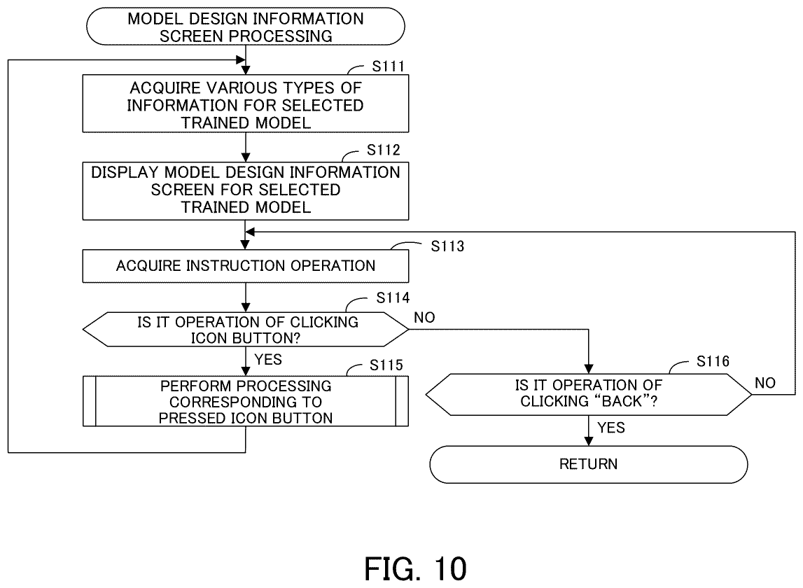

Next, model design information screen processing will be described. The model design information screen processing is processing performed as the processing of S104 when it is determined that the processor 201 has received an operation of selecting an AI model (trained model) in the determination processing of S103 of the re-learning support processing of FIG. 8. FIG. 10 is a flowchart illustrating processing details in an example of model design information screen processing;

When the processing of FIG. 10 is started, first, various types of information for the trained model selected by the operation in the determination processing of S103 of the re-learning support processing is acquired from the storage 203 in S111.

Through the processing of S111, one or a plurality of pieces of version information for the selected trained model and design information corresponding to the version information are acquired from the model design information DB 500. Model-related information for the selected trained model is acquired from the model-related file information DB 600. Further, video (training video) data, annotation data, and a loss function value specified by the file name indicated by the acquired model-related information are acquired from the storage 203.

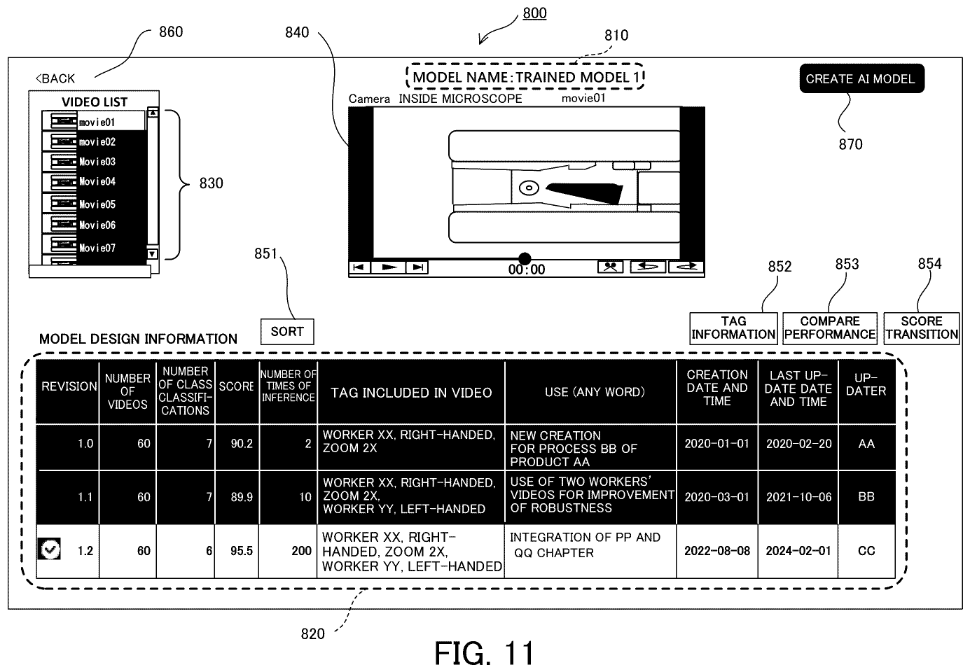

Next, in S112, a model design information screen 800 exemplified in FIG. 11 is created using the various types of information acquired by the processing of S111, and displayed on the monitor 300.

Here, a first example of the model design information screen 800 illustrated in FIG. 11 will be described.

The model design information screen 800 includes a first display area 810, a second display area 820, a video selection area 830, and a video display area 840.

The processor 201 displays the name of the selected trained model in the first display area 810 as information of the selected trained model through the processing of S112. In addition, through this processing, the processor 201 displays design information (the time information, the person information, the training information, and the textual information described above) for the selected trained model in association with the information of “revision” that is the version information in the second display area 820.

The design information displayed in the first display area 810 and the design information displayed in the second display area 820 are information acquired from the model design information DB 500. By referring to the design information, the model developer who performs trained model update work can easily grasp the intention and the background of the design at the time of creating the model, and in particular, can appropriately recognize the difference between revisions in the intention and the background of the design.

The design information for each revision of the trained model displayed in the second display area 820 is displayed in a mode in which design information for at least one revision is selected (a mode in which the design information is shown in black characters on a white background in the example of FIG. 11). By executing the processing of S112, the processor 201 displays a list of training videos used for learning in creating the trained model of the selected revision and acquired by the processing of S111 in the video selection area 830. Here, when a click operation is performed on the design information for the non-selected revision in the second display area 820, the selection of the revision is changed, and the processor 201 displays a list of training videos for the newly selected revision in the video selection area 830.

Furthermore, in the display of the list of training videos in the video selection area 830, one of the displayed training videos is displayed in a selected mode (a mode in which the video file name is shown in black characters on a white background in the example of FIG. 11). The processor 201 displays a moving image of the training video displayed in the selected mode in the video display area 840. Note that selection of the training video in the display of the list in the video selection area 830 is also changed by an operation of clicking a non-selected training video in the display of the list, and the processor 201 displays a moving image of the newly selected training video in the video display area 840.

The model design information screen 800 further includes a sort button 851, a tag information button 852, a performance comparison button 853, and a score transition button 854, which are icon buttons, and a “back” button 860 and an “AI model creation” button 870. When a click operation is performed on such a button, the display on the monitor 300 is switched from the model design information screen 800 to various screens associated with the clicked button.

Referring back to FIG. 10, the description will be made. When the model design information screen 800 is displayed on the monitor 300 by the processing of S112, next, an instruction operation on the input device 400 is acquired in S113. Then, in S114, it is determined whether the acquired instruction operation is an operation of clicking one of the icon buttons described above.

When it is determined in the determination processing of S114 that the acquired instruction operation is an operation of clicking one of the icon buttons, processing associated with the icon button on which the click operation has been performed is executed in S115. Such processing will be described in detail later.

Thereafter, when the processing of S115 ends, the processing returns to S111, and information about the selected trained model is acquired again, and a model design information screen 800 is displayed by the subsequent processing of S112 again.

On the other hand, when it is determined in the determination processing of S114 that the acquired instruction operation is not an operation of clicking one of the icon buttons, the processing proceeds to S116. Then, in S116, it is determined whether the instruction operation acquired by the processing of S113 is an operation of clicking the “back” button 860. In this determination processing, when it is determined that the instruction operation is an operation of clicking the “back” button 860, this model design information screen processing ends, and the processing returns to the re-learning support processing of FIG. 8.

On the other hand, when it is determined in the determination processing of S116 that the instruction operation is not an operation of clicking the “back” button 860, the processing returns to S113, and an instruction operation on the input device 400 is acquired again. At this time, in response to an operation instruction related to the model design information screen 800, the processor 201 may execute other processing according to the operation instruction.

The processing described so far is model design information screen processing.

In the following description, various types of processing performed as the processing of S115 in the model design information screen processing will be described.

### [3: Sorting Processing]

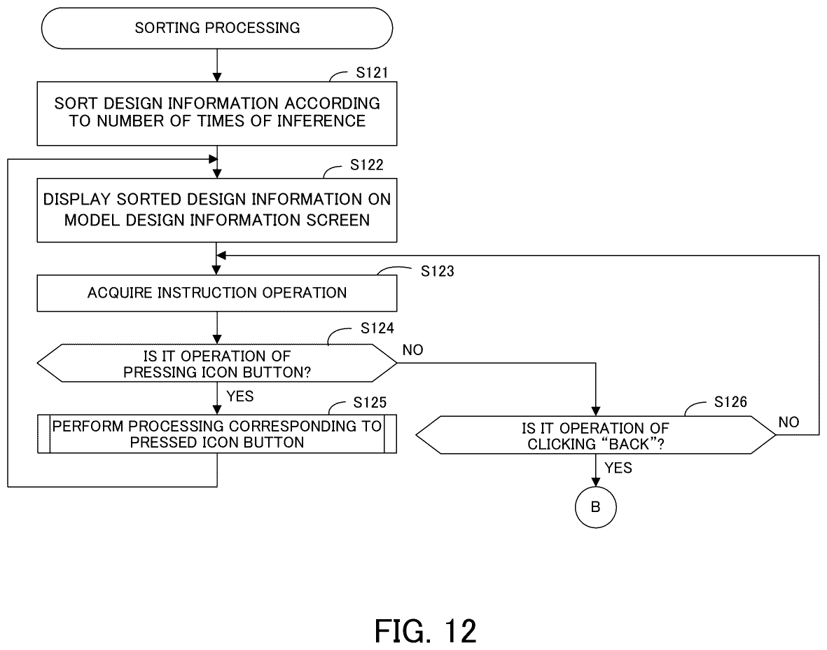

First, sorting processing will be described. FIG. 12 is a flowchart illustrating processing details in an example of sorting processing.

This sorting processing is processing executed by the processor 201 as the processing of S115 in a case where the instruction operation acquired by the processing of S113 in the model design information screen processing is an operation of clicking the sort button 851. This processing is processing of rearranging the design information for all the revisions of the trained model to be displayed in descending order of the “number of times of inference” in the second display area 820 of the model design information screen 800.

As described above, the number of times of inference is information about the number of times of classification from the video of the assembly process to video segments for the respective tasks actually using the trained model. Therefore, the trained model having a large number of times of inference is estimated to be a model that is highly suitable for the intention of the design of the model and has high performance. By rearranging the display in this manner, it is possible for a model developer who uses the re-learning support system 1 to easily grasp the relative relationship in performance level between all the revisions of the trained model.

When the processing of FIG. 12 is started, first, in S121, the design information displayed for all the revisions in the second display area 820 on the model design information screen 800 are sorted in descending order of the “number of times of inference”. Then, in subsequent S122, the design information for all the revisions is displayed according to the sorted order in the second display area 820 on the model design information screen 800.

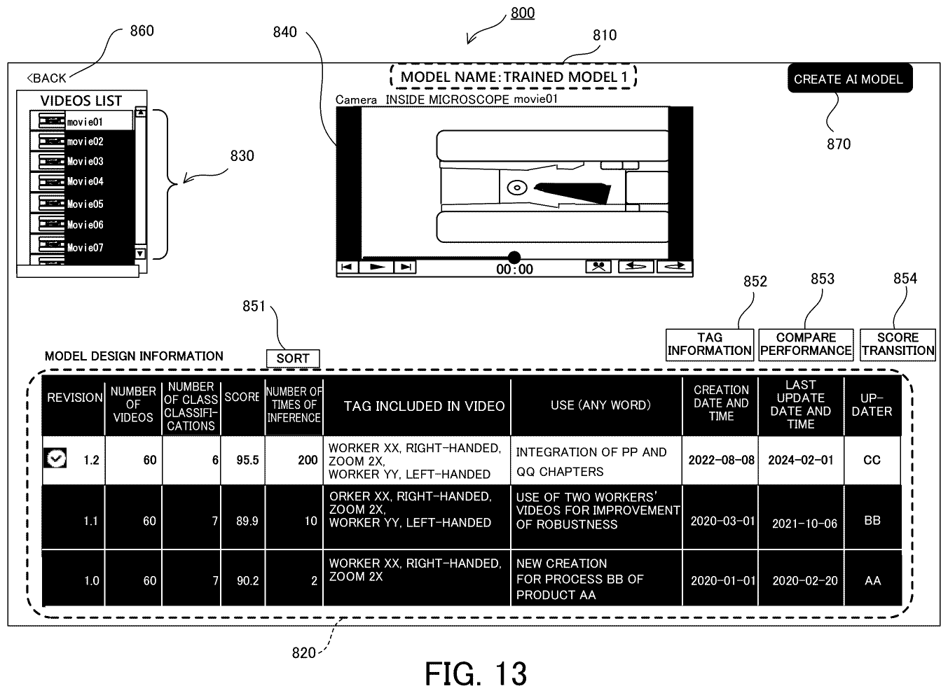

FIG. 13 illustrates a second example of the model design information screen 800. In the second example, the design information for all the revisions displayed in the second display area 820 in the first example illustrated in FIG. 11 is sorted according to the “number of times of inference”. In the first example illustrated in FIG. 11, the design information for all the revisions is arranged in chronological order of creation date (in ascending order of revision), whereas in the second example, the design information for all the revisions is rearranged in descending order of the “number of times of inference”.

Returning to the description with reference to FIG. 12, when the design information for all the revisions is displayed in the sorted order by the processing of S122, next, an instruction operation on the input device 400 is acquired in S123. Then, in S124, it is determined whether the acquired instruction operation is an operation of clicking one of the icon buttons described above.

When it is determined in the determination processing of S124 that the acquired instruction operation is an operation of clicking one of the icon buttons, processing associated with the icon button on which the click operation has been performed is executed in S125. Such processing will be described in detail later.

Thereafter, when the processing of S125 ends, the processing returns to S122, and the model design information screen 800 in which the design information for all the revisions is displayed in descending order of the “number of times of inference” is displayed again.

On the other hand, when it is determined in the determination processing of S124 that the acquired instruction operation is not an operation of clicking one of the icon buttons, the processing proceeds to S126. Then, in S126, it is determined whether the instruction operation acquired by the processing of S123 is an operation of clicking the “back” button 860. In this determination processing, when it is determined that the instruction operation is an operation of clicking the “back” button 860, the sorting processing ends, the processing proceeds to the re-learning support processing of FIG. 8, and the processing of S101 is performed to display a model selection screen 700.

On the other hand, when it is determined in the determination processing of S126 that the instruction operation is not an operation of clicking the “back” button 860, the processing returns to S123, and an instruction operation on the input device 400 is acquired again.

The processing described so far is sorting processing.

Note that, in the sorting processing exemplified in FIG. 12, the design information for all the revisions is sorted to be displayed in the order according to the number of times of inference. Alternatively, the design information for different revisions may be sorted to be displayed in the order on the basis of other design information. That is, for example, the design information for all the revisions may be sorted to be displayed in descending order of use period of the trained model of each revision. Note that the use period of the trained model of a certain revision is, for example, a period from the creation date of the trained model of the certain revision to the creation date of the trained model of the next revision subsequent to the certain revision.

### [4: Video Tag Information Screen Processing]

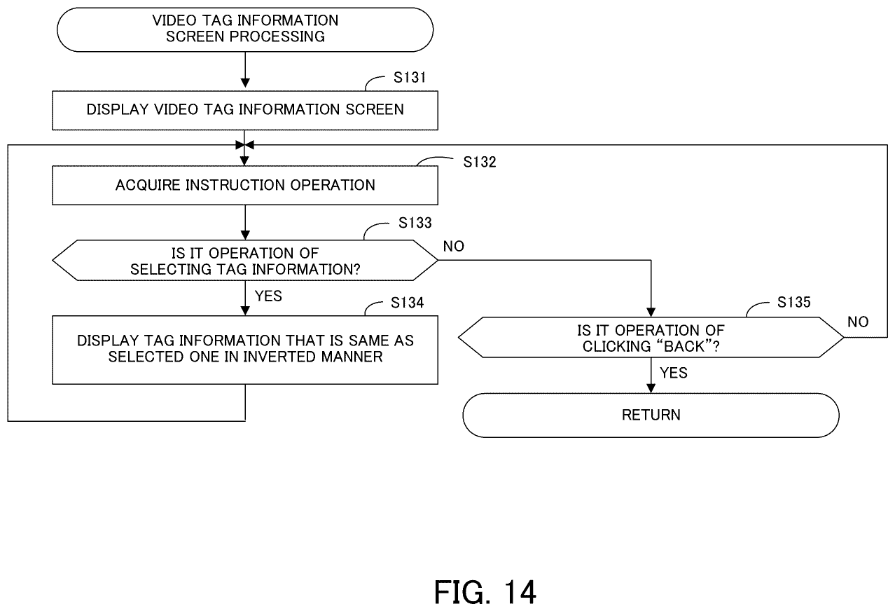

Next, video tag information screen processing will be described. FIG. 14 is a flowchart illustrating processing details in an example of video tag information screen processing.

The video tag information screen processing is executed by the processor 201 as the processing of S115 in a case where the instruction operation acquired by the processing of S113 in the model design information screen processing of FIG. 10 is an operation of clicking the tag information button 852. In addition, even in a case where the instruction operation acquired by the processing of S123 in the sorting processing of FIG. 12 is an operation of clicking the tag information button 852, this processing is executed by the processor 201 as the processing of S125.

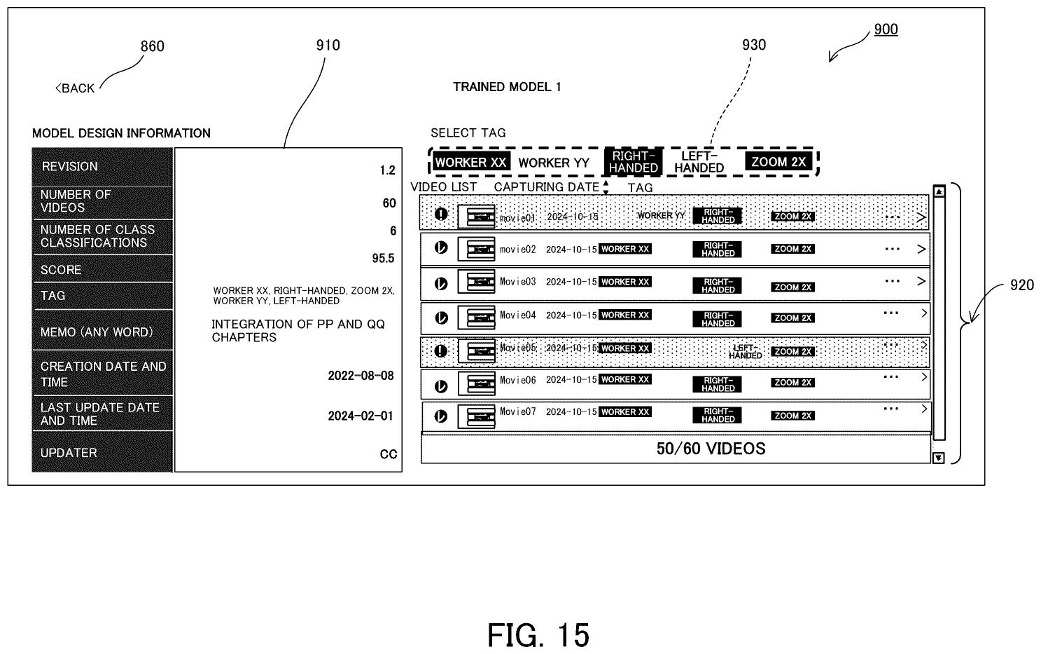

When the processing of FIG. 14 is started, first, in S131, a video tag information screen 900 exemplified in FIG. 15 is displayed on the monitor 300.

Here, the video tag information screen 900 exemplified in FIG. 15 will be described.

The video tag information screen 900 is a screen that indicates tag information attached to data of the training video in association with the training video for each training video used for machine learning at the time of creating the trained model. By referring to the video tag information screen 900, the model developer who performs trained model update work can easily grasp the situation at the time of acquiring the training videos.

The video tag information screen 900 includes a design information display area 910, a tag information list display area 920, and a tag information selection area 930.

The design information display area 910 is an area in which design information for the trained model is displayed. On the model design information screen 800 of FIG. 11 or FIG. 13, design information for the revision selected in the second display area 820 when the operation of clicking the sort button 851 is performed is displayed in the design information display area 910.

The tag information list display area 920 is an area for displaying a list of training videos used for learning at the time of creating the trained model of the revision for which design information is displayed in the design information display area 910 and the tag information attached to the respective pieces of data of the training videos in association with each other. The tag information list display area 920 is an example of a third display area.

The tag information selection area 930 is an area for individually selecting tag information among the design information for the trained model of the revision displayed in the design information display area 910.

In the example of FIG. 15, five items, “worker XX”, “right-handed”, “zoom 2X”, “worker YY”, and “left-handed”, are shown as tag information in the design information display area 910. These are tag information attached to any of the training videos used for learning at the time of creating the trained model of the revision for the design information is displayed in the design information display area 910. These five items are displayed in the tag information selection area 930.

When click operations are performed on these items displayed in the tag information selection area 930, the item on which the click operation has been performed is displayed in an inverted display mode (a mode in which white characters representing the item are shown on a black background). At this time, the display mode also changes to the inverted display mode for the tag information of the same item displayed in association with the training videos in the tag information list display area 920.

In the example of FIG. 15, three items, “worker XX”, “right-handed”, and “zoom 2X”, among the five items displayed in the tag information selection area 930 are displayed in the inverted display mode, indicating that these three items are selected. Furthermore, it is illustrated in FIG. 15 that the tag information “worker XX”, “right-handed”, and “zoom 2X” displayed in association with the training videos in the tag information list display area 920 is changed to be displayed in the inverted display mode by this selection.

As described above, in response to the reception of the selection of the tag information in the tag information selection area 930, the selected tag information and the training videos related to the selected tag information are displayed on the video tag information screen 900. By displaying such a video tag information screen 900 on the monitor 300, it is possible to provide a model developer who performs trained model update work with a determination material for selecting training videos in re-learning for updating the trained model.

Returning to the description with reference to FIG. 14, in the processing of S131, first, design information is acquired for the trained model of the revision selected in the second display area 820 when the operation of clicking the sort button 851 on the model design information screen 800 is performed. Then, the display of the design information display area 910 is created using the acquired design information. Furthermore, by referring to the model-related file information DB 600 at this time, the video files of training videos used for learning at the time of creating the trained model of the revision selected in the second display area 820 are specified. Then, the tag information is acquired from the video files, and the display of the tag information list display area 920 is created by associating the acquired tag information and the training video for each training video. Furthermore, the display of the tag information selection area 930 is created using the tag information included in the design information displayed in the design information display area 910. The processor 201 displays the video tag information screen 900 in which the display of each area is created in this manner on the monitor 300.

Next, in S132, an instruction operation on the input device 400 is acquired. Then, in S133, it is determined whether the acquired instruction operation is an operation of clicking any of the tag information displayed in the tag information selection area 930.

When it is determined in the processing of S133 that the instruction operation is an operation of clicking the tag information, tag information that is the same as the one on which the click operation has been performed in the tag information list display area 920 and the tag information selection area 930 are displayed in an inverted manner in S134. Thereafter, the processing returns to S132, and the processing continues by acquiring an instruction operation on the input device 400.

On the other hand, when it is determined in the processing of S133 that the instruction operation is not an operation of clicking the tag information, it is determined whether the instruction operation is an operation of clicking a back button 860 included in the video tag information screen 900 in S135. In this determination processing, when it is determined that the instruction operation is an operation of clicking the “back” button 860, this video tag information screen processing ends, and the processing returns to the original processing, that is, the model design information screen processing or the sorting processing.

On the other hand, when it is determined in the determination processing of S135 that the instruction operation is not an operation of clicking the “back” button 860, the processing returns to S132, and an instruction operation on the input device 400 is acquired again.

### [5: Model Performance Comparison Screen Processing]

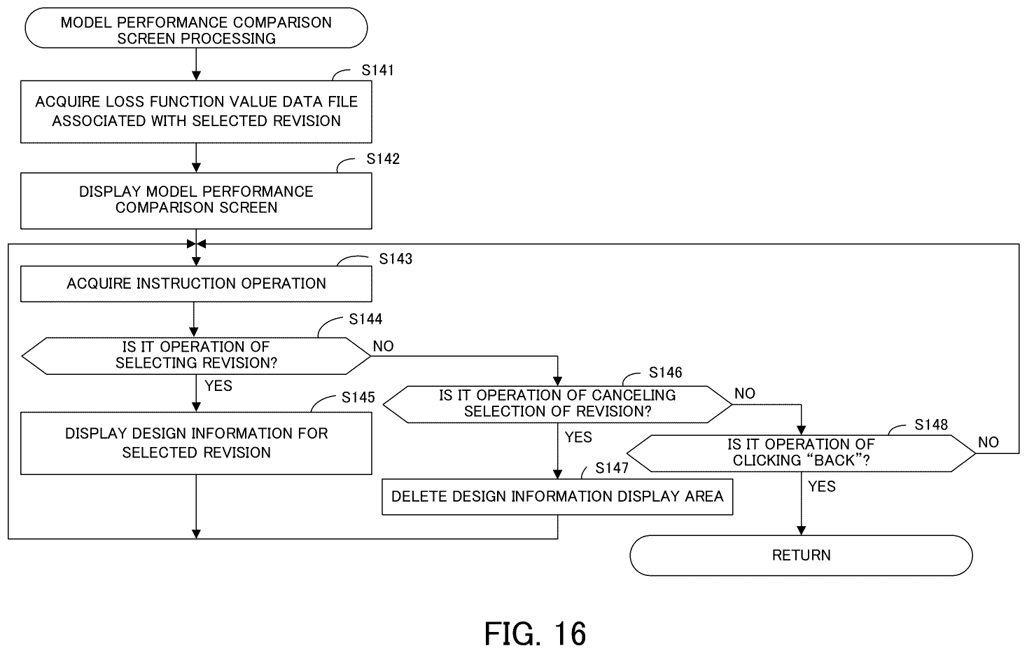

Next, model performance comparison screen processing will be described. FIG. 16 is a flowchart illustrating processing details in an example of model performance comparison screen processing.

The model performance comparison screen processing is executed by the processor 201 as the processing of S115 in a case where the instruction operation acquired by the processing of S113 in the model design information screen processing of FIG. 10 is an operation of clicking the performance comparison button 853. In addition, even in a case where the instruction operation acquired by the processing of S123 in the sorting processing of FIG. 12 is an operation of clicking the performance comparison button 853, this processing is executed by the processor 201 as the processing of S125.

When the processing of FIG. 16 is started, first, in S141, a loss function value data file associated with the revision of the trained model selected in the second display area 820 of the model design information screen 800 is read and acquired from the storage 203.

In the processing of S141, first, information about the revision indicating the version of the trained model selected in the second display area 820 when the operation of clicking the performance comparison button 853 is performed on the model design information screen 800 is acquired. At this time, in a case where a plurality of revisions are selected in the second display area 820, information about all the selected revisions is acquired. Next, with reference to the model-related file information DB 600, a loss function value data file name corresponding to each of the acquired revisions is acquired, and a loss function value data file specified by the acquired file name is read from the storage 203.

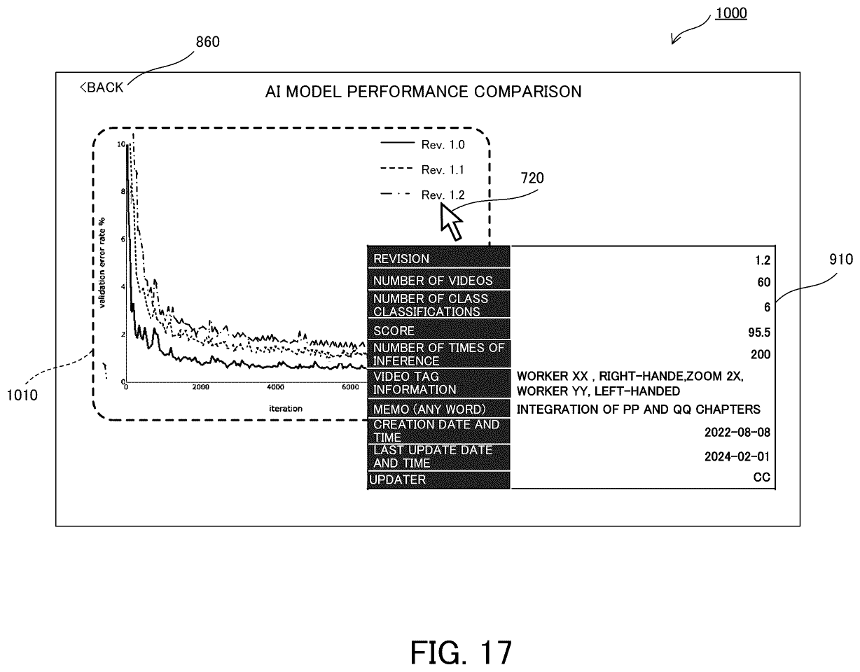

Next, in S142, a model performance comparison screen 1000 exemplified in FIG. 17 is displayed on the monitor 300, the model performance comparison screen 1000 including a graph of loss function value data created using data included in the loss function value data file obtained by the processing of S141.

Here, the model performance comparison screen 1000 illustrated in FIG. 17 will be described. The model performance comparison screen 1000 is a screen that displays information indicating the performance of the trained model for each revision. By referring to the model performance comparison screen 1000, the model developer who performs trained model update work can easily compare the performances of the trained model for all the revisions.

The model performance comparison screen 1000 includes a performance comparison display area 1010. In the performance comparison display area 1010, graphs of loss function value data for all the revisions are displayed in a superimposed manner as information indicating the performances of the trained model for the respective revisions.

In the example of FIG. 17, graphs of loss function value data for the trained model of three revisions selected in the second display area 820 of the model design information screen 800, “1.0”, “1.1”, and “1.2”, are displayed in the performance comparison display area 1010. The graph of loss function value data is a graph indicating a relationship between the number of iterations of learning and a loss function value in machine learning at the time of generating the trained model. Such a display mode in which graphs of loss function value data for a plurality of revisions are superimposed is an example of a display mode in which information indicating the performances of the trained model for the plurality of revisions can be compared.

Note that, in the example of FIG. 17, the three graphs are shown to be distinguished by different line types, but instead, for example, the three graphs may be shown to be distinguished by different line colors.

When the mouse pointer 720 points to the graph of loss function value data or the legend display for the graph in the performance comparison display area 1010 by operating the input device 400 while the model performance comparison screen 1000 is displayed, the design information display area 910 appears. The design information display area 910 is an area in which information about the trained model of the revision of which loss function value is indicated by the graph or the legend display pointed to by the mouse pointer 720 is displayed. The example of FIG. 17 illustrates a state in which the design information for the trained model of the revision “1.2” is displayed in the design information display area 910 by the mouse pointer 720 pointing to the legend display for the revision “1.2”.

Returning to the description with reference to FIG. 16, in the processing of S142, graphs of the loss function value data for all the revisions are created from the data included in the respective loss function value data files read by the processing of S141. Then, the display of the performance comparison display area 1010 is created by superimposing the graphs. In this manner, the processor 201 displays the model performance comparison screen 1000 in which the display of the performance comparison display area 1010 is created on the monitor 300.

Next, in S143, an instruction operation on the input device 400 is acquired. Then, in S144, it is determined whether the acquired instruction operation is an operation of selecting a revision of the trained model by selecting a graph or a legend display in the performance comparison display area 1010.

When it is determined in the determination processing of S144 that the instruction operation is an operation of selecting a revision, the processing proceeds to S145. Then, in S145, the design information display area 910 is displayed in a popped-up manner, the design information for the trained model of the selected revision is acquired from the model design information DB 500, and the acquired design information is displayed in the design information display area 910. Thereafter, the processing returns to S143, and an instruction operation is acquired again.

On the other hand, when it is determined in the determination processing of S144 that the instruction operation is not an operation of selecting a revision, the processing proceeds to S146. Then, in S146, it is determined whether the acquired instruction operation is an operation of canceling the selection of the revision by moving the mouse pointer 720 from the performance comparison display area 1010.

When it is determined in the determination processing of S146 that the instruction operation is an operation of canceling the selection of the revision, the processing proceeds to S147. Then, in S147, the popped-up display of the design information display area 910 is deleted from the model performance comparison screen 1000, returning the screen to the original screen. Thereafter, the processing returns to S143, and an instruction operation is acquired again.

On the other hand, when it is determined in the determination processing of S146 that the instruction operation is not an operation of canceling the selection of the revision, the processing proceeds to S148. Then, in S148, it is determined whether the acquired instruction operation is an operation of clicking the “back” button 860 included in the model performance comparison screen 1000. In this determination processing, when it is determined that the instruction operation is an operation of clicking the “back” button 860, this model performance comparison screen processing ends, and the processing returns to the original processing, that is, the model design information screen processing or the sorting processing.

On the other hand, when it is determined in the determination processing of S148 that the instruction operation is not an operation of clicking the “back” button 860, the processing returns to S143, and an instruction operation on the input device 400 is acquired again.

### [6: Score Transition Display Screen Processing]

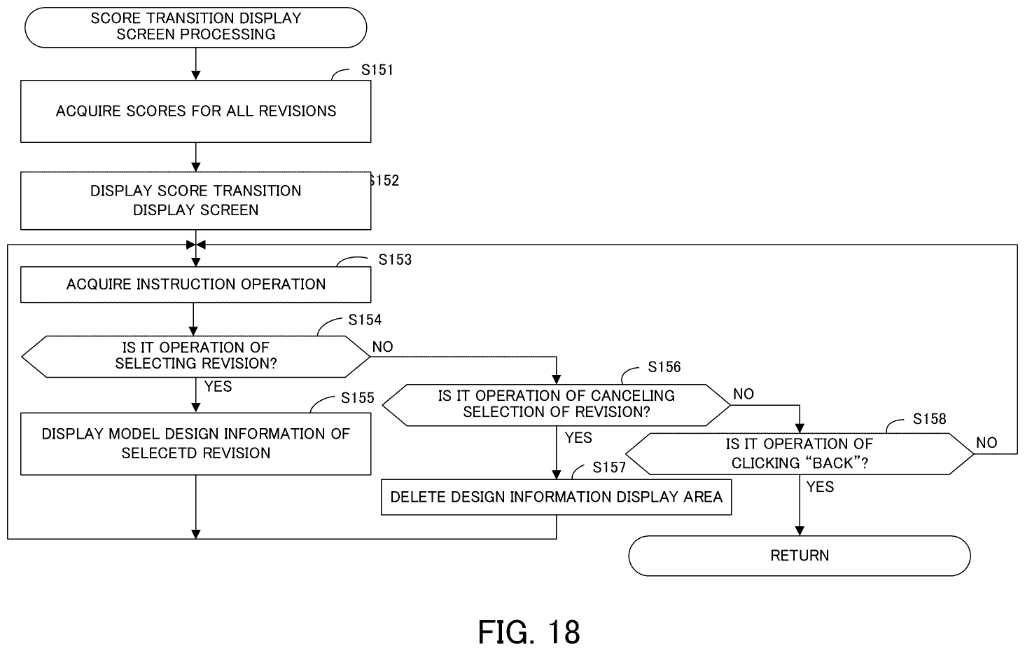

Next, score transition display screen processing will be described. FIG. 18 is a flowchart illustrating processing details in an example of score transition display screen processing.

The score transition display screen processing is executed by the processor 201 as the processing of S115 in a case where the instruction operation acquired by the processing of S113 in the model design information screen processing of FIG. 10 is an operation of clicking the score transition button 854. In addition, even in a case where the instruction operation acquired by the processing of S123 in the sorting processing of FIG. 12 is an operation of clicking the score transition button 854, this processing is executed by the processor 201 as the processing of S125.

When the processing of FIG. 18 is started, first, in S151, score values of the revisions for the trained model of which the design information is displayed on the model design information screen 800 that is being displayed are acquired from the model design information DB 500 of the storage 203.

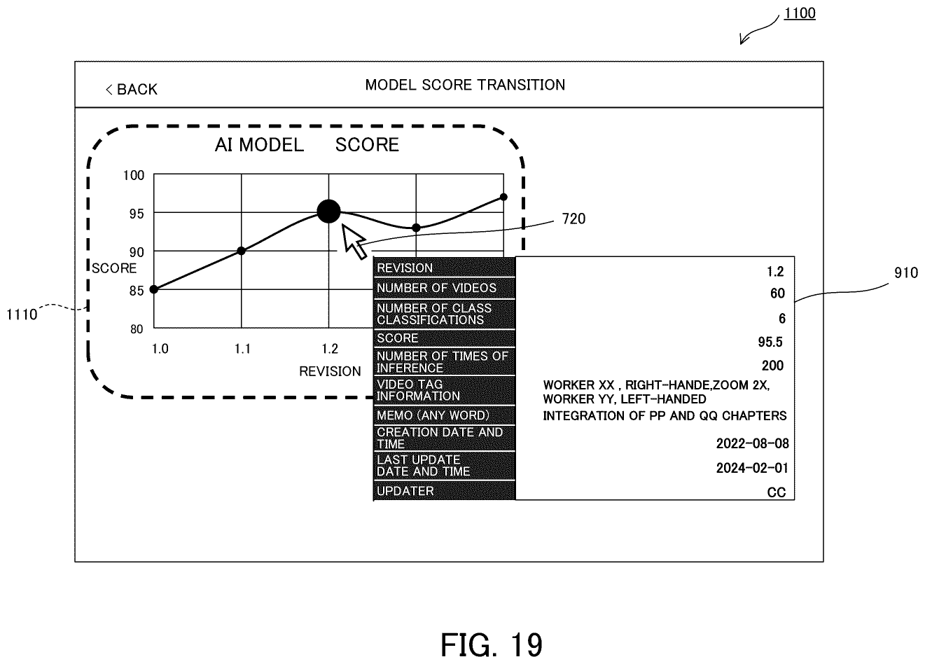

Next, in S152, a score transition display screen 1100 exemplified in FIG. 19 is displayed on the monitor 300, the score transition display screen 1100 including a score transition graph created using the scores for all the revisions obtained by the processing of S151.

Here, the score transition display screen 1100 illustrated in FIG. 19 will be described. The score transition display screen 1100 is a screen that displays the transition between the scores in time series by expressing the above-described scores, which is information indicating the reliabilities of the trained model for all the revisions, in association with the respective revisions. By referring to the score transition display screen 1100, the model developer who performs trained model update work can easily grasp the transition of reliability level of the model caused by the update of the trained model performed in the past.

The score transition display screen 1100 includes a score transition graph display area 1110. The score transition graph display area 1110 is an area for displaying a score transition graph. The score transition graph is a graph indicating the transition between the scores for the trained model. This graph is created by smoothly connecting points at which the revisions, which are version information about the trained model, are associated with the scores of the trained model in the respective revisions in the order of creation of the trained model of the respective revisions.

The score transition graph illustrated in the score transition graph display area 1110 in the example of FIG. 19 is obtained by plotting points indicating the scores of the trained model in the respective revisions and smoothly connecting these points in the order of the revisions “1.0”, “1.1”, “1.2”, and so on.

When the input device 400 is operated while the score transition display screen 1100 is displayed, and the mouse pointer 720 points to a point indicating the score for each revision in the score transition graph in the score transition graph display area 1110 or the vicinity thereof, the design information display area 910 appears. The design information display area 910 is an area in which information about the trained model of the revision of which the score is indicated at or near the position pointed to by the mouse pointer 720 is displayed. The example of FIG. 19 illustrates a state in which the design information for the trained model of the revision “1.2” is displayed in the design information display area 910 by the mouse pointer 720 pointing to the legend display for the revision “1.2”.

Returning to the description with reference to FIG. 19, in the processing of S152, a score transition graph is created from the values of the scores acquired by the processing of S151. The processor 201 displays a score transition display screen 1100 in which the created score transition graph is displayed in the score transition graph display area 1110 on the monitor 300.

Next, in S153, an instruction operation on the input device 400 is acquired. Then, in S154, it is determined whether the acquired instruction operation is an operation of selecting a revision of the trained model by selecting a score in the score transition graph in the score transition graph display area 1110 is performed.

When it is determined in the determination processing of S154 that the instruction operation is an operation of selecting a revision, the processing proceeds to S155. Then, in S155, the design information display area 910 is displayed in a popped-up manner, the design information for the trained model of the selected revision is acquired from the model design information DB 500, and the acquired design information is displayed in the design information display area 910. Thereafter, the processing returns to S153, and an instruction operation is acquired again.

On the other hand, when it is determined in the determination processing of S154 that the instruction operation is not an operation of selecting a revision, the processing proceeds to S156. Then, in S156, it is determined whether the acquired instruction operation is an operation of canceling the selection of the revision by moving the mouse pointer 720 from the score transition graph display area 1110.

When it is determined in the determination processing of S156 that the instruction operation is an operation of canceling the selection of the revision, the processing proceeds to S157. Then, in S157, the popped-up display of the design information display area 910 is deleted from the score transition display screen 1100, returning the screen to the original screen. Thereafter, the processing returns to S153, and an instruction operation is acquired again.

On the other hand, when it is determined in the determination processing of S156 that the instruction operation is not an operation of canceling the selection of the revision, the processing proceeds to S158. Then, in S158, it is determined whether the acquired instruction operation is an operation of clicking the “back” button 860 included in the score transition display screen 1100. In this determination processing, when it is determined that the instruction operation is an operation of clicking the “back” button 860, this score transition display screen processing ends, and the processing returns to the original processing, that is, the model design information screen processing or the sorting processing.

On the other hand, when it is determined in the determination processing of S158 that the instruction operation is not an operation of clicking the “back” button 860, the processing returns to S153, and an instruction operation on the input device 400 is acquired again.

### [7: Re-Learning Processing]

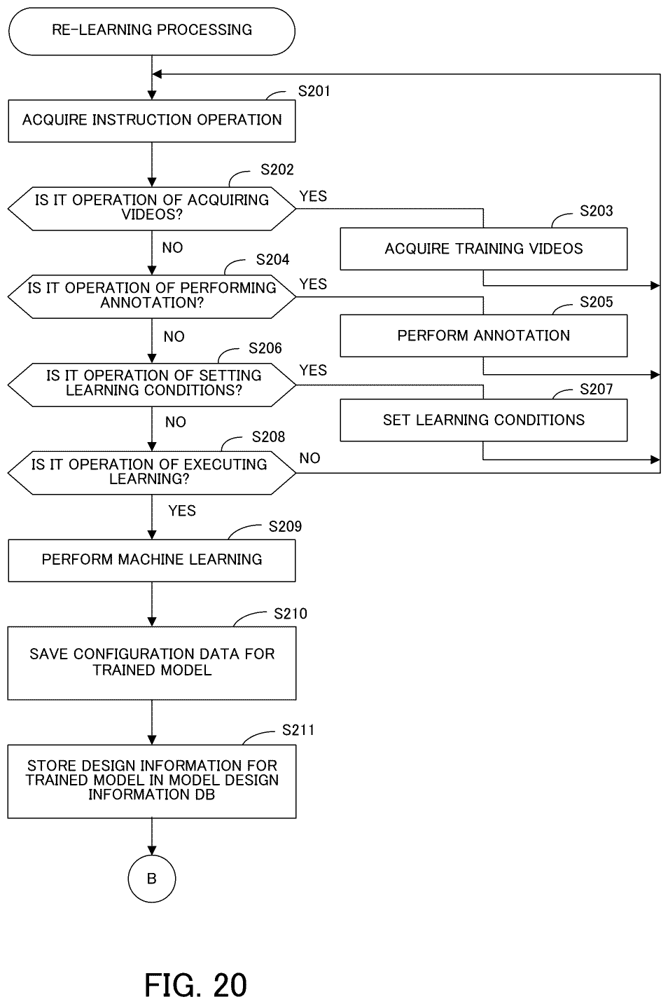

Next, re-learning processing will be described. FIG. 20 is a flowchart illustrating processing contents in the re-learning processing.

The re-learning process is executed by the processor 201 as the processing of S115 in a case where the instruction operation acquired by the processing of S113 in the model design information screen processing of FIG. 10 is an operation of clicking the “AI model creation” button 870. In addition, even in a case where the instruction operation acquired by the processing of S123 in the sorting processing of FIG. 12 is an operation of clicking the “AI model creation” button 870, this processing is executed by the processor 201 as the processing of S125.

As the work in S21 of FIG. 2, the model developer who performs trained model update work grasps the intention and the background of the design at the time of creating the old version of the AI model by referring to the screen displayed by the various types of processing described so far. Thereafter, the model developer performs the subsequent review work in S22, and performs the work in and after S23 according to the result of the review. The re-learning processing is processing for the work in and after S23.

When the execution of the processing of FIG. 20 is started, first, in S201, an instruction operation on the input device 400 is acquired. Then, in the subsequent determination processing of each of S202, S204, S206, and S208, the instruction content indicated by the instruction operation is determined.

When it is determined in the determination processing of S202 that the instruction operation indicates an instruction to acquire videos, training videos are acquired in S203. This processing is processing for acquiring training videos, and is processing for work of additionally acquiring training videos, which is the work in S24 of the AI model update work illustrated in FIG. 2.

When it is determined in the determination processing of S204 that the instruction operation indicates an instruction to execute annotation, annotation is performed in S205. This processing is processing for adding annotations to the training videos, and is processing for assigning annotations to the training videos or changing the assigned annotations, which is the work in S26 of the AI model update work illustrated in FIG. 2.

When it is determined in the determination processing of S206 that the instruction operation indicates an instruction to set learning conditions, learning conditions are set in S207. This processing is processing for setting learning conditions in machine learning for creating an AI model, and is processing for work of resetting learning conditions, which is the work in S28 of the AI model update work illustrated in FIG. 2.

When the processing of S203, S205, or S207 described above ends, the processing returns to S201, and a new instruction operation is acquired again.

On the other hand, when it is determined in the determination processing of S208 that the instruction operation indicates an instruction to execute machine learning, machine learning is performed in S209. This processing is processing for performing machine learning to create an AI model according to the set learning conditions, and is processing for the work in the procedures of S15 to S20 in FIG. 1 as re-learning in the AI model update work.

Thereafter, when the machine learning of S209 is completed, configuration data for the trained model created by the machine learning after re-learning is saved in the storage 203 in S210. Then, in subsequent S211, design information for the trained model obtained after re-learning is stored in the model design information DB 500 of the storage 203 in association with a revision that is version information indicating the version of the trained model obtained after re-learning.

After the processing of S211 ends, the re-learning processing ends, the processing proceeds to the re-learning support processing of FIG. 8, and the processing of S101, which is processing for displaying the model selection screen 700, is performed.

When the instruction content indicated by the instruction operation cannot be determined by any of the determination processing of S202, S204, S206, and S208, the processing returns to S201, and a new instruction operation is acquired again.

The processing described so far is re-learning processing.

As described above, the re-learning support system 1 presents the design information for the trained model for all created versions (revision) of the trained model, making it easy to appropriately recognize differences in design information between the versions of the trained model created in the past. Since the re-learning support system 1 is configured as described above, it is possible to support work for re-training the trained model, and the model developer who performs trained model update work can easily perform the re-learning work.

The above-described embodiments are specific examples to facilitate understanding of the invention, and the present invention is not limited to these embodiments. Modifications obtained by modifying the above-described embodiments and alternatives to the above-described embodiments may also be included. That is, in the above-described embodiments, the components can be modified without departing from the spirit and scope thereof. In addition, new embodiments can be implemented by appropriately combining a plurality of components disclosed in the above-described embodiments. Furthermore, some components may be omitted from among the components described in the embodiments, or some components may be added to the components described in the embodiments. Furthermore, the processing procedures described in the embodiments may be changed as long as there is no contradiction. In other words, the re-learning support system according to the present invention can be variously modified and altered without departing from the scope defined by the claims.

For example, in the above-described embodiments, the configuration data for the trained model, the model design information DB 500, and the model-related file information DB 600 are individually stored in the storage 203 of the computer 200a as the control device 200. Alternatively, the design information stored in the model design information DB 500 and the information on various file names stored in the model-related file information DB 600 may be embedded in the configuration data of the corresponding version of the trained model and individually stored in the storage 203.

Note that, in the present specification, the expression “on the basis of A” does not indicate “on the basis of only A” but means “on the basis of at least A” and further means “partially on the basis of at least A”. That is, “on the basis of A” may mean “on the basis of B in addition to A” or “on the basis of a part of A”.

What is claimed is:

1. A re-learning support system comprising:
a storage and a processor,
wherein the storage is configured to store:
one or more trained models trained using at least one microscopic image;
one or more pieces of version information associated with each of the trained models and indicating versions of the trained model; and
one or more pieces of design information for the trained model associated with the one or more pieces of version information, and
the processor is configured to:
receive a selection of at least one of the trained models;
acquire the one or more pieces of version information and the one or more pieces of design information for the selected trained model from the storage;
display information about the selected trained model in a first display area of a display; and
display the acquired version information and the acquired design information in association with each other in a second display area of the display.

2. The re-learning support system according to claim 1, wherein the design information includes at least one of time information, person information, training information, and textual information.

3. The re-learning support system according to claim 2, wherein
the training information includes the number of times of inference and a score, and
the processor is configured to display the number of times of inference and the score in the second display area in association with the version information.

4. The re-learning support system according to claim 2, wherein the design information further includes information observed by a microscope when the microscopic image used to generate the trained model is acquired.

5. The re-learning support system according to claim 1, wherein when the trained model having the version information is re-trained, design information for the trained model after being re-trained is stored in the storage in association with version information indicating a version of the trained model after being re-trained.

6. The re-learning support system according to claim 1, wherein the processor is configured to receive the selection of the at least one of the trained models by using a selection screen displayed on the display.

7. The re-learning support system according to claim 1, wherein
the at least one microscopic image is an image obtained from one or more moving images,
the storage is configured to further store the moving images, and
the processor is configured to display the moving images in a third display area of the display.

8. The re-learning support system according to claim 7, wherein
the design information includes tag information,
the storage is configured to further store the tag information in association with the moving images, and
the processor is further configured to:
receive a selection among the tag information; and
display the selected tag information and moving images associated with the selected tag information in association with each other on the display.

9. The re-learning support system according to claim 1, wherein the processor is configured to change a display order in which the version information and the design information associated with each other are displayed in the second display area based on the design information.

10. The re-learning support system according to claim 1, wherein the processor is further configured to display, on the display, a plurality of pieces of version information corresponding to the selected trained model and information indicating performances of the trained model in versions indicated by the version information.

11. The re-learning support system according to claim 10, wherein the processor is further configured to:
receive a selection of the plurality of pieces of version information; and
display information indicating the performances of the selected plurality of pieces of version information on the display in a comparable display mode.

12. The re-learning support system according to claim 1, wherein the processor is further configured to display, on the display in time series, a plurality of pieces of version information corresponding to the selected trained model and scores indicating reliabilities of the trained model in versions indicated by the version information.

13. A re-learning support method performed by a computer, the re-learning support method comprising:
receiving a selection of one or more trained models trained using at least one microscopic image;
acquiring one or more pieces of version information and one or more pieces of design information for the selected trained models from a storage that stores one or more trained models, one or more pieces of version information associated with each of the trained models and indicating versions of the trained model, and one or more pieces of design information for the trained model associated with the one or more pieces of version information;
displaying information about the selected trained model in a first display area of a display; and
displaying the acquired version information and the acquired design information in association with each other in a second display area of the display.

14. A computer-readable storage medium storing a re-learning support program causing a computer to perform:
receiving a selection of one or more trained models trained using at least one microscopic image;
acquiring one or more pieces of version information and one or more pieces of design information for the selected trained models from a storage that stores one or more trained models, one or more pieces of version information associated with each of the trained models and indicating versions of the trained model, and one or more pieces of design information for the trained model associated with the one or more pieces of version information;
displaying information about the selected trained model in a first display area of a display; and
displaying the acquired version information and the acquired design information in association with each other in a second display area of the display.
